(19) United States
(12) Patent Application Publication
(10) Pub. No.: US 2011/0064574 A1
(43) Pub. Date: Mar. 17, 2011

(54) METHOD AND APPARATUS FOR EXTRACTING FLUID MOTION ENERGY

(76) Inventor: William G. Lange, Mission Viejo, CA (US)

(21) Appl. No.: 12/732,954

(22) Filed: Mar. 26, 2010

Related U.S. Application Data
(60) Provisional application No. 61/243,108, filed on Sep. 16, 2009.

(51) Int. Cl. F03D 3/02; F03D 3/00; F03D 11/00; F03D 11/02

(52) U.S. Cl. 416/1; 416/223 R; 416/120; 416/169 R

(57) ABSTRACT

An apparatus for extracting fluid motion energy, comprising one or more blades. Each blade comprising one or more vanes. Each vane having an exposed area. The exposed area when impinged by fluid motion, that is generally in the direction of the movement of a blade, is larger than the exposed area when not impinged by fluid motion. And the exposed area when impinged by fluid motion, that is generally opposing the direction of the movement of the blade, is smaller than the exposed area when not impinged by fluid motion.

### RELATED APPLICATIONS

This application is related to and claims priority from U.S. Provisional Patent Application Ser. No. 61/243,108 filed Sep. 16, 2009, for “Vertical Axis Wind Turbine” with inventor William George Lange.

### FIELD

This disclosure relates to extracting energy from fluid motion. More particularly there is presented a Fluid Motion Energy Extraction Device, FMEED, for converting fluid that is in motion in relation to the FMEED into electrical energy.

### BACKGROUND

Fluid Motion Energy Extraction Devices, FMEEDs, in the form of wind turbines are divided into two operational categories: Horizontal Axis Wind Turbines, HAWT, and Vertical Axis Wind Turbines, VAWT. HAWTs are movable axis wind turbines. While VAWT are fixed axis wind turbines.

Wind turbines comprise blades that interact with moving fluids, in this case the wind, to extract the fluid motion energy. The blades and other rotational masses that accompany the blades can be referred to as the turbine disc.

HAWTs are called Horizontal Axis Wind Turbines because of the relative orientation of their axis of rotation as being horizontal to the surface of the earth. HAWT may also be described as having the axis of rotation operational in a similar geometric plane as the plane in which the fluid is in motion or in this case the wind.

HAWT designs require special design considerations to enable changes in alignment of the axis of rotation so that the axis can be made parallel to the fluid flow direction. Only when the axis of rotation is moved or aligned, so that it is made to be parallel to the wind, are the turbine blades properly presented to the wind so that the HAWT may operate. Sophisticated electronics, many sensors and large precise costly motors are required to move the HAWT just to achieve basic operation.

VAWT designs are called Vertical axis wind turbines because of the relative orientation of their axis of rotation as perpendicular to the surface of the earth or vertical. VAWT may also be described as having the axis of rotation operational perpendicular to the plane in which the fluid is flowing.

VAWT designs can be further divided into two general categories which refer to how the blades interact with the wind, Lift and Drag. Lift VAWT rely on special aerodynamic qualities of the turbine blade design to enable rotation slightly faster than the prevailing wind speeds. Drag designs rotate at or slightly slower than the prevailing wind speed.

The invention is made with the above discussed problems in mind and aims to address the related problems.

### SUMMARY OF THE INVENTION

An apparatus for extracting fluid motion energy, comprising one or more blades. Each blade comprising one or more vanes. Each vane having an exposed area. The exposed area when impinged by fluid motion, that is generally in the direction of the movement of a blade, is larger than the exposed area when not impinged by fluid motion. And the exposed area when impinged by fluid motion, that is generally opposing the direction of the movement of the blade, is smaller than the exposed area when not impinged by fluid motion.

Additional features and benefits of the present invention will become apparent from the detailed description, figures and claims set forth below.

### BRIEF DESCRIPTION OF THE DRAWINGS

FIG. 1 is a drawing of a wind farm depicting Fluid Motion Energy Extraction Devices, FMEEDs in the form of Horizontal Axis Wind Turbines, HAWTs, and Vertical Axis Wind Turbines, VAWTs which are depicted in the manner of the instant disclosure and will be referred to as the Erin Turbine;

FIG. 2 is a closer view of just the Erin Turbine portion of the wind farm;

FIG. 3 is a drawing of one Erin Turbine;

FIG. 4 is a closer view of a three blade Erin Turbine;

FIG. 5 is a cross section view of one blade of an Erin Turbine;

FIG. 6 is a drawing one blade of the Erin Turbine and the relative fluid motion forces acting on the blade.

### DETAILED DESCRIPTION OF AN EMBODIMENT OF THE INVENTION

The description and accompanying drawings are for purposes of illustration and are not to be used to construe the disclosure in a restrictive manner. In the following disclosure, details are set forth in order to provide an understanding of the invention. However, it will be apparent to one of skill in the art that the invention can be practiced without these details.

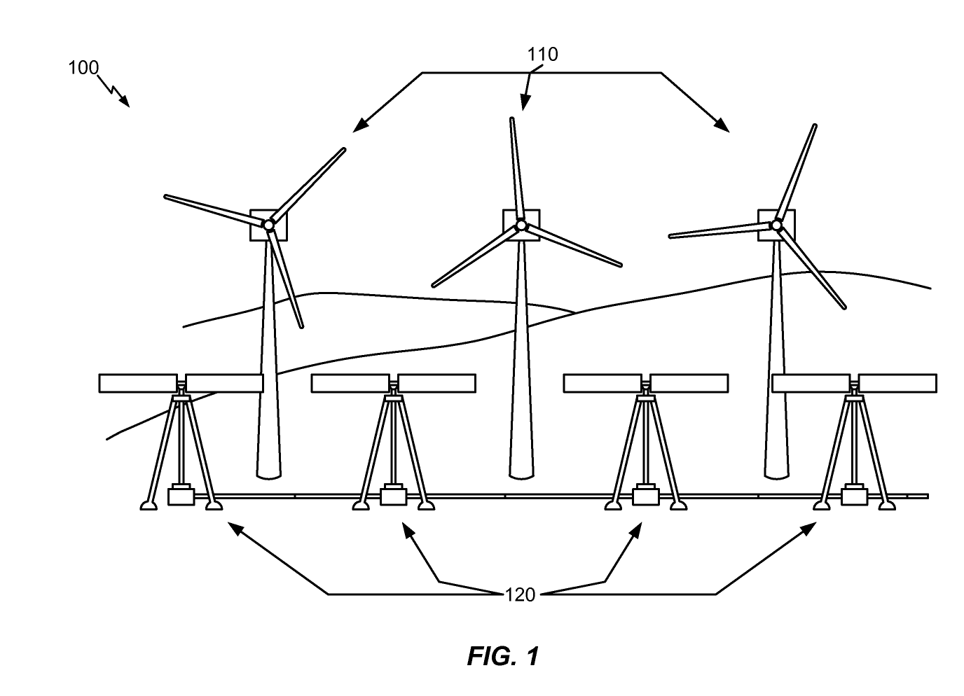

Turning now to FIG. 1 of the accompanying drawings there is shown Wind Farm 100. Operational in Wind Farm 100 are Fluid Motion Energy Extraction Devices, FMEEDs in the form of Horizontal Axis Wind Turbines, HAWT, 110 and Vertical Axis Wind Turbines, VAWT 120. VAWT 120 is depicted as described in the instant disclosure and hereafter will be referred to as the Erin Turbine.

Those of skill in the art would understand that benefits of the disclosed Erin Turbine 120 comprises adaptability to a wide range of levels of sophistication. In a simplified or less sophisticated form the Erin Turbine 120 is very inexpensive, can be made using materials on hand and can be operated and maintained without complex expensive procedures or personnel training. In a more sophisticated form, many parameters of the Erin Turbine 120 can be controlled, adjusted and monitored. The discussion here addresses a generally moderate level of sophistication and should in no way be considered limiting to the disclosure.

Those of skill in the art would understand that the Erin Turbine 120 is adaptable to operate in many different fluids. The discussion addresses using the Erin Turbine 120 in a wind farm 100. The energy of our atmosphere or air, a fluid, which has been put into motion by atmospheric conditions, is the energy the FMEEDs use to extract and convert to electrical energy. This should in no way be considered limiting as to the type of fluid in which the Erin Turbine 120 is operable.

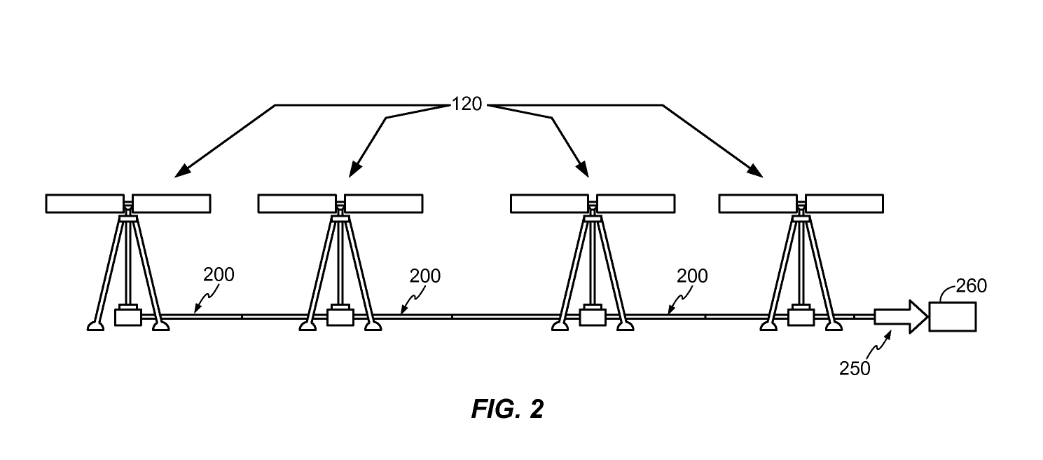

FIG. 2 shows a set of four Erin Turbines 120 similar to those indicated in wind farm 100. Erin Turbines 120 are connected by shaft 200. Shaft 200 may be one piece or segmented into many pieces. Shaft 200 connects Erin Turbines 120 by way of transmissions 210. Energy transmitted through shaft 200 culminates into output 250. Output 250 is delivered to energy conversion equipment 260.

Those of skill in the art would understand that energy captured by the Erin Turbine 120 can be distributed in many forms comprising direct attachment to other devises where the captured energy is directly used. This direct connection uses the converted energy without an intermediate conversion to electricity. For example the Erin Turbine 120 may be directly connected to an irrigation pump.

Those of skill in the art would also understand that the Erin Turbine 120 can be positioned in a diverse way across a wind farm 100. The Erin Turbine 120 can stand alone or be operationally connected to other Erin Turbines. The Erin Turbines 120 can be located varying distances between each other. The number of groupings and number of FMEEDs in each group of Erin Turbines 120 can be adjusted. Relative elevations can be different. Relative angles between Erin Turbines 120 can be diverse also. The rotational axis of each Erin Turbine can be adjusted in relation to the earth to place the rotational axis perpendicular to the average prevailing air flow.

Diversity of positioning of Erin Turbines 120 enables designers to select positions so that output 250 is an average of the energies extracted across the wind farm 100. Output 250 from a grouping of four Erin Turbines 120 can therefore be more stable. The term stable in this regard refers to reducing the magnitude and/or frequency of torque and speed that might be applicable to a single Erin Turbine due to natural cycles of wind speed and force for a single wind farm position.

Drive shaft 200, associated transmissions and other items may be located below ground to enhance safe operation, reduce noise and enhance durability through reduced exposure to the elements.

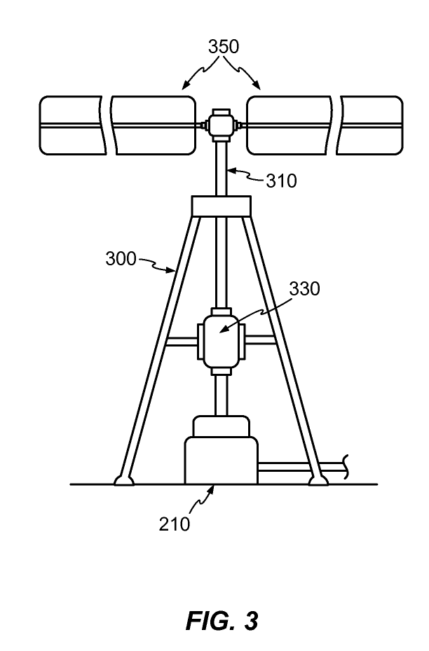

FIG. 3 shows one Erin Turbine 120 in more detail. Structure 300 supports axis shaft 310 such that axis shaft 310 can rotate. Transmission 210 enables redirection of the rotation of axis shaft 310 to another plane of rotation. Disconnect/brake 330 positioned on axis shaft 310 enables stopping of rotation of the turbine disc or upper portion of Erin Turbine 120 and temporary disconnection of axis shaft 310 with the turbine disc or the upper portion of Erin Turbine 120. This disconnection would facilitate maintenance efforts with regard to the turbine disc. The disconnection would also allow maintenance to be performed on one Erin Turbine 120 without interruption of service for the group of Erin Turbines to which Erin Turbine 120 is operationally connected.

Turbine blades 350 are operationally connected to shaft 310.

Structure 300 has multiple legs with a wider stance at the bottom to enhance stability. Rotation of axis shaft 310 is transferred to ground level for distribution by way of axis shaft 310. Since multiple Erin Turbines 120 can be operationally connected, many Erin Turbines 120 can be positioned across a wind farm 100 without a corresponding increase in cost due to the number of generators used. Therefore the number of points of possible energy extraction for a given wind farm 100 in relation to the overall cost of the wind farm 100 can be increased. By having more turbines economically available a wind farm can extract more energy than would have been possible with fewer wind turbines.

Erin Turbine 120 is unaffected by changes in wind direction. The turbine disc comprised of blades 350 rotates in a horizontal plane or within the plane in which the wind is blowing. The Erin Turbine 120 is operational with fluid impinging the blades at any point 360 degrees around the turbine disc.

Erin Turbine 120 rotational axis can stay generally fixed during operation. However, adjustments can be made as appropriately determined by those of skill in the art.

Rotating blade assemblies or turbine discs act like gyroscopes. The physical properties of gyroscopes can be described as having a tendency to resist any force imposed on the gyroscope to change the alignment of the rotational axis. Rotational speed, total mass and distribution of mass across the spinning disc contribute to the magnitude of the forces required to alter the alignment of the axis of rotation. Since the Erin Turbine 120 turbine disc is generally fixed on one plane, the gyroscopic effect of the turbine disc of Erin Turbine 120 tends to resist changes in axis orientation. These forces work to stabilize the Erin Turbine 120 structure during gusty wind conditions or during wind direction changing conditions.

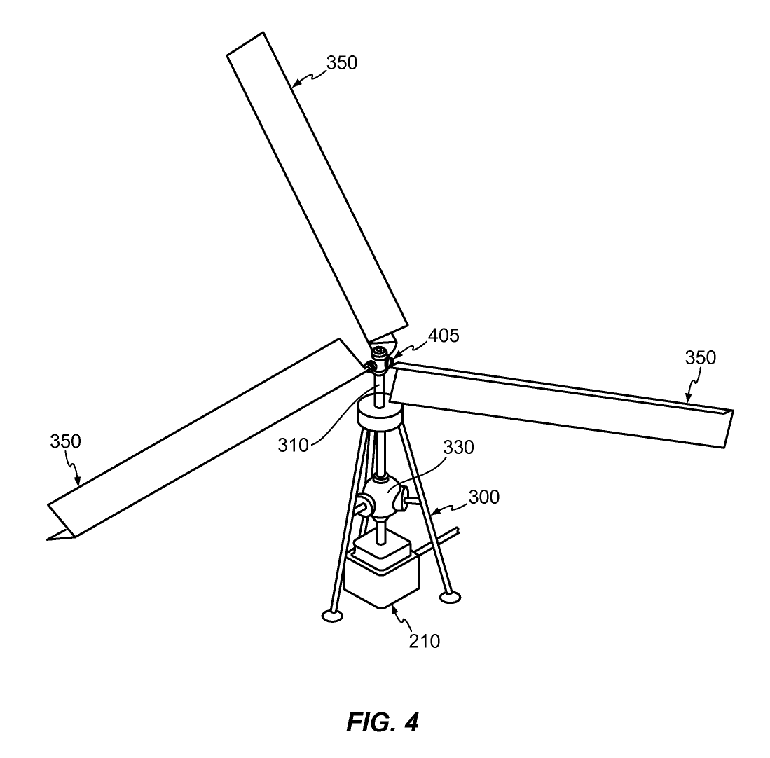

FIG. 4 shows in more detail the blades of Erin Turbine 120 where three blades are used in the design. One or more blades can be used for an Erin Turbine 120. Blades 350 are shown attached commonly to a central hub 405. The direction of rotation of Erin Turbine 120 can be easily reversed by rotating each blade 180 degrees at the attachment point with hub 405.

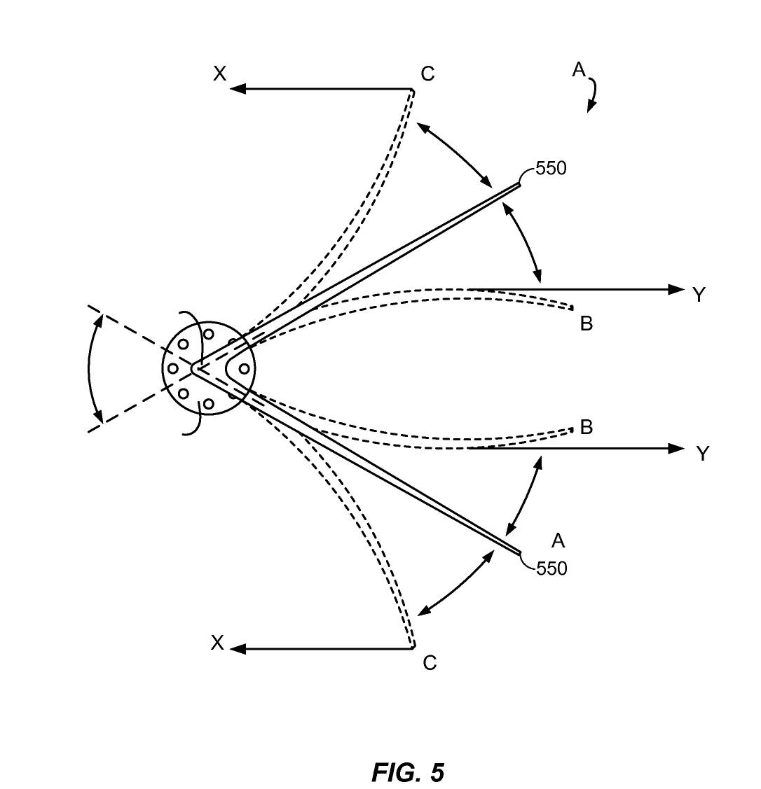

FIG. 5 shows in more detail cross section of Blade 350. At rest, blade 350 is similar to a wedge when viewed in cross section. The at rest position is designated at A. One or more vanes 550 can be used. Here two vanes 550 are shown. The edge of blade 350 with the vanes 550 is considered the rear. The edge at the front of the tip of the “v” in the generally wedge shape is considered the front.

The trailing edges of each blade are designed to partially spread open on the downwind portion of each rotation or when the wind is hitting the blade 350 from the rear. Wind direction is indicated by X. This position is designated as position C.

And the trailing edges of each blade 350 are designed to partial flex closed on the upwind portion of each rotation when the wind is hitting the front of the blade 350. Wind direction I sindicated by Y. This position is designated as position B. During a rotation of the turbine disc the vanes 550 flex open and closed creating a change of cross sectional exposure to the prevailing wind.

The area that the fluid impinges on the blades is called the total exposed area. The total exposed area is directly related to the exposed area of the vanes. When the vanes 550 flex outward because they are being pushed on by the wind from the rear, the exposed area is larger than when the vanes are at static state or there is no wind. And when the vanes 550 flex inward because they are being pushed on by the wind from the front the exposed area is smaller than at static state.

The fluid force exerted on an object is related to the size of the object. In the instant case the force exerted by the wind on the blades 350 of the Erin Turbine 120 will be related to the size of the exposed area for the blades 350. Since the exposed area is larger on one side of the Erin Turbine 120 and smaller on the other side of the Erin Turbine 120 when the wind blows, there is a differential in force about the rotational axis making the Erin Turbine 120 rotate.

Since the wind impinges the blades 350 in the same plane of rotation of the turbine disc, there is efficient use of the wind energy to apply force to the blades 350. The force exerted along the length of the blades 350 creates torque which then rotates the disc. In this regard the Erin Turbine 120 is robust with regard to torque.

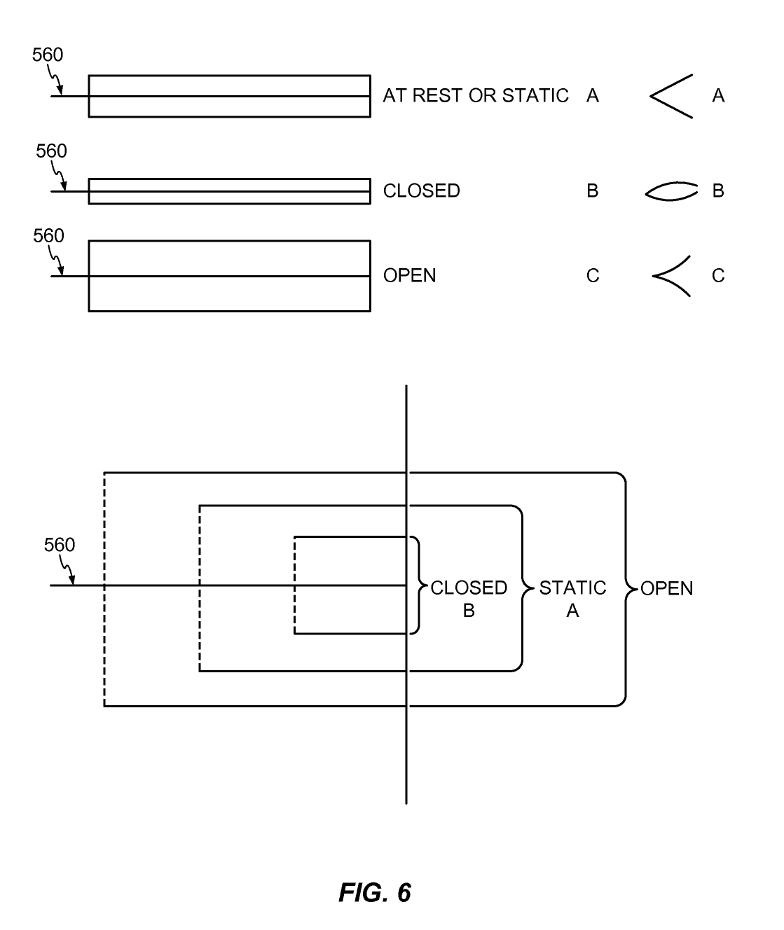

FIG. 6 shows the change in exposed area of blade 350 due to interaction with the wind. Representation A shows how the vanes react when there is no wind. Representation B shows how the vanes react when the wind impinges blade 350 from the front. Representation C shows how the vanes react when the wind impinges blade 350 from the rear.

The Erin Turbine 120 is self regulating in speed of rotation. The degree of flexibility and the speed of flexibility of vanes 550 and therefore of blade 350 are determined by the material used for the vanes and by the design. Therefore design considerations and material selection set the speed at which the Erin Turbine will rotate for a given wind speed. In this regard the speed of rotation is self governing.

When a turbine disc rotates, the fastest point on the blades of the turbine disc are at the tips. As the tip speed increases for Erin Turbine 120 the effect of wind speed acting upon the vanes at the tips for the down wind moving blade diminishes. In other words the vanes tend close or the exposed area tends to get smaller. When the exposed area shrinks the total force on that area decreases. This tends to regulate the maximum rotation speed for the Erin Turbine 120 for a given wind speed.

Alternatively, as the tip speed increases for the Erin Turbine 120 the effect of the wind on the vanes at the tips that are advancing into the wind increases. This too tends to regulate the maximum rotation speed for the Erin Turbine 120.

The differential between the additional force acting on the advancing side and the lesser force acting on the retreating side tends to regulate the speed of the Erin Turbine 120 over a range of different wind speeds.

In the foregoing detailed description, the present invention has been described with reference to specific exemplary embodiments. It will be evident that various modifications and changes may be made without departing from the broader scope and spirit of the present invention. The specification and figures are accordingly to be regarded as illustrative rather than restrictive.

1. An apparatus for extracting fluid motion energy, comprising:
one or more blades, each blade comprising:
one or more vanes, each vane having an exposed area, the exposed area when impinged by fluid motion that is generally in the direction of the movement of a blade is larger than the exposed area when not impinged by fluid motion and
the exposed area when impinged by fluid motion that is generally opposing the direction of the movement of the blade is smaller than the exposed area when not impinged by fluid motion.

2. The apparatus of claim 1 wherein the exposed area is consistent along the length of the blade.

3. The apparatus of claim 1 wherein the exposed area varies along the length of the blade.

4. The apparatus of claim 1 wherein the blade is not straight.

5. The apparatus of claim 1 further comprising a hub for attaching the one or more blades to a shaft, the shaft oriented generally perpendicular to the fluid motion flow and capable of rotating about its longitudinal axis.

6. The apparatus of claim 5 further comprising;
a transmission operationally connected to the shaft.

7. The apparatus of claim 6 further comprising;
a combination brake-disconnect.

8. The apparatus for averaging fluid motion energy on a wind farm, comprising;
a power transmission shaft;
an Erin Turbine one, operationally connected to the power transmission shaft;
an Erin Turbine two, operationally connected to the power transmission shaft; and,
an energy conversion equipment, operationally connected to Erin Turbine two, wherein the Erin Turbines are not co-located on the wind farm.

9. The apparatus of claim 8 wherein more than two Erin Turbines are connected to the power transmission shaft.

10. A method for extracting fluid motion energy, comprising:
selecting a location for an Erin Turbine; and
positioning the Erin Turbine in the selected location, the Erin Turbine comprising:
one or more blades, each blade comprising:
one or more vanes, each vane having an exposed area, the exposed area when impinged by fluid motion that is generally in the direction of the movement of a blade is larger than the exposed area when not impinged by fluid motion and the exposed area when impinged by fluid motion that is generally opposing the direction of the movement of the blade is smaller than the exposed area when not impinged by fluid motion.

11. The method of claim 10 further comprising:
selecting multiple locations for multiple Erin Turbines;
positioning the multiple Erin Turbines; and,
connecting operationally the multiple Erin Turbines.

12. The method of claim 10 wherein the selected location for the Erin Turbine is on a wind farm.
